(19) United States
(12) Patent Application Publication
(10) Pub. No.: US 2008/0118095 A1
(43) Pub. Date: May 22, 2008

(54) WAX GUARD FOR A HEARING AID

(76) Inventor: Thomas G. Fletcher, Millgrove (CA)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 11/766,994

(22) Filed: Jun. 22, 2007

Related U.S. Application Data
(60) Provisional application No. 60/860,769, filed on Nov. 22, 2006.

(51) Int. Cl. H04R 25/00

(52) U.S. Cl. 381/328

(57) ABSTRACT

An apparatus for use with hearing aid tubes includes a wax guard configured as a sleeve. The sleeve has an open end, a closed end, and a chamber extending between the open and closed ends. The sleeve further has vents from the chamber to the exterior of the sleeve. An inner wall structure extends from the closed end of the sleeve toward the open end and partitions the chamber into vented compartments. Each vented compartment is configured to receive a hearing aid tube inwardly through the open end.

### RELATED APPLICATIONS

This application claims the benefit of Provisional U.S. Patent Application No. 60/860,769, filed Nov. 22, 2006, which is incorporated into this application by reference.

### TECHNICAL FIELD

This technology relates to a hearing aid that is worn in a user's ear.

### BACKGROUND

A hearing aid worn in a user's ear may be provided with a wax guard that blocks ear wax from entering or interfering with the hearing aid.

### SUMMARY

An apparatus for use with hearing aid tubes comprises a wax guard configured as a sleeve. The sleeve has an open end, a closed end, and a chamber extending between the open and closed ends. The sleeve further has vents from the chamber to the exterior of the sleeve. An inner wall structure extends from the closed end of the sleeve toward the open end and partitions the chamber into vented compartments. Each vented compartment is configured to receive a hearing aid tube inwardly through the open end.

### BRIEF DESCRIPTION OF THE DRAWINGS

FIG. 1 is a side view, partly in section, of a hearing aid with a wax guard.

FIG. 2 is a view similar to FIG. 1, showing the wax guard separately from the hearing aid.

FIG. 3 is a view taken on line 3-3 of FIG. 2.

FIG. 4 is a perspective view of the wax guard.

FIG. 5 is a sectional side view of the wax guard.

FIG. 6 is a view taken on line 6-6 of FIG. 5.

FIG. 7 is a view taken on line 7-7 of FIG. 5.

FIG. 8 is a view taken on line 8-8 of FIG. 5.

FIG. 9 is a view taken on line 9-9 of FIG. 5.

### DETAILED DESCRIPTION

The apparatus shown in the drawings has parts that are examples of the elements recited in the claims. The following description thus includes examples of how a person of ordinary skill in the art can make and use the claimed invention. It is presented here to meet the statutory requirements of written description, enablement, and best mode without imposing limitations that are not recited in the claims.

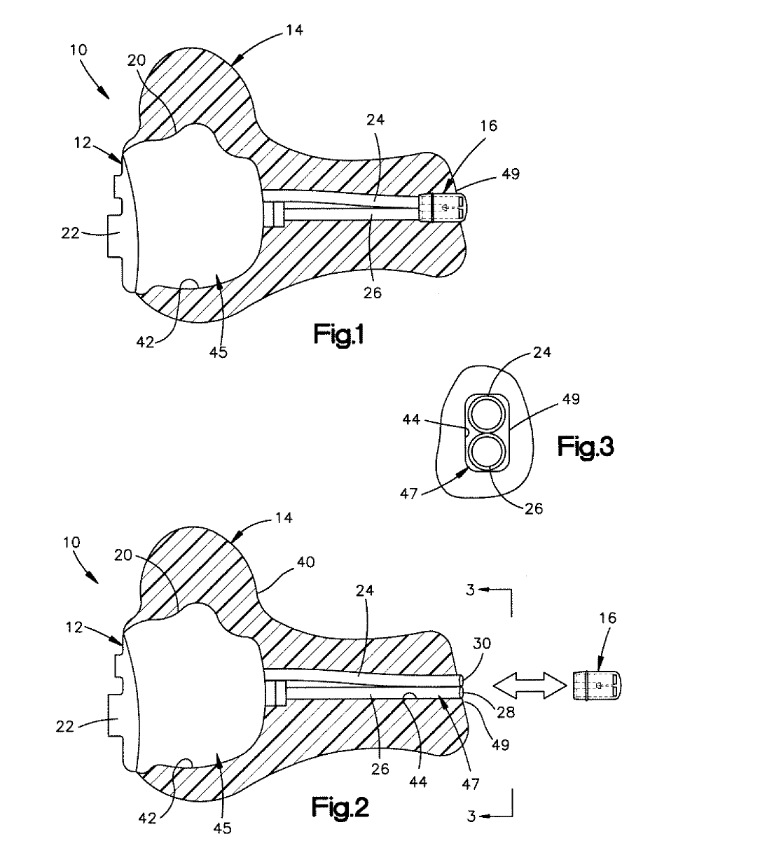

FIGS. 1 and 2 show a hearing aid 10 that has two major parts. These are an electronic device 12 and an ear mould 14. The ear mould 14 is configured to support the electronic device 12 within a user's ear. Also shown in FIGS. 1 and 2 is an ear wax exclusion device 16 that blocks ear wax from entering or interfering with the hearing aid 10. The ear wax exclusion device 16, which may be referred to as a wax guard, is removable and replaceable at the inner end of the hearing aid 10.

The electronic device 12 has a rigid housing 20 containing sound amplifying circuitry and other parts configured for operation of the hearing aid 10 in a known manner. A control interface 22, which is shown schematically in the drawings, is located on the housing 20. A flexible vent tube 24 and a flexible sound tube 26 project from the housing 20. As shown in FIG. 2, the tubes 24 and 26 have open ends 28 and 30 in adjacent positions at the inner end of the hearing aid 10.

The ear mould 14 is formed of soft, flexible material such as silicone or the like, and is formed in a mould such that the peripheral surface 40 of the ear mould 14 has a contour to fit closely within the user's ear. A removable mould insert (not shown) provides the ear mould 14 with first and second inner surfaces 42 and 44. The first inner surface 42 defines a chamber 45 that is sized and shaped to receive the electronic device housing 20 in a close fit in the installed position shown in FIGS. 1 and 2. The second inner surface 44 defines an elongated passage 47 with an opening 49 (FIG. 2) at the peripheral surface 40. The tubes 24 and 26 extend through the passage 47 from the chamber 45 to the opening 49. The flexibility of the ear mould 14 enables the user to remove the electronic device 12 from the ear mould 14 for replacement of either of those two parts.

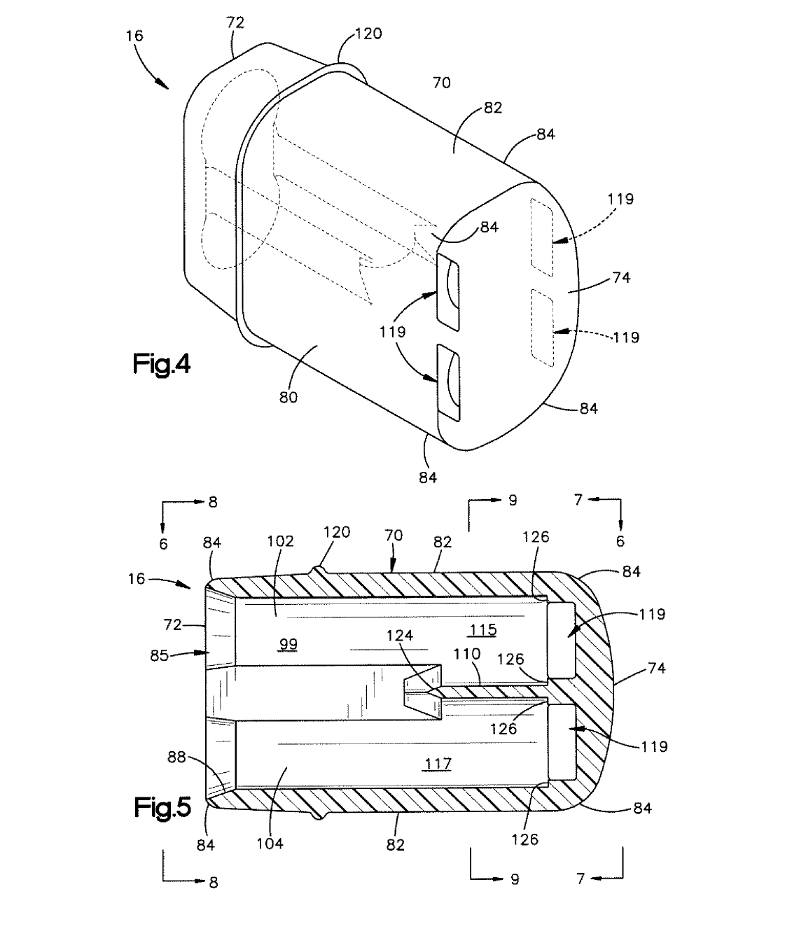

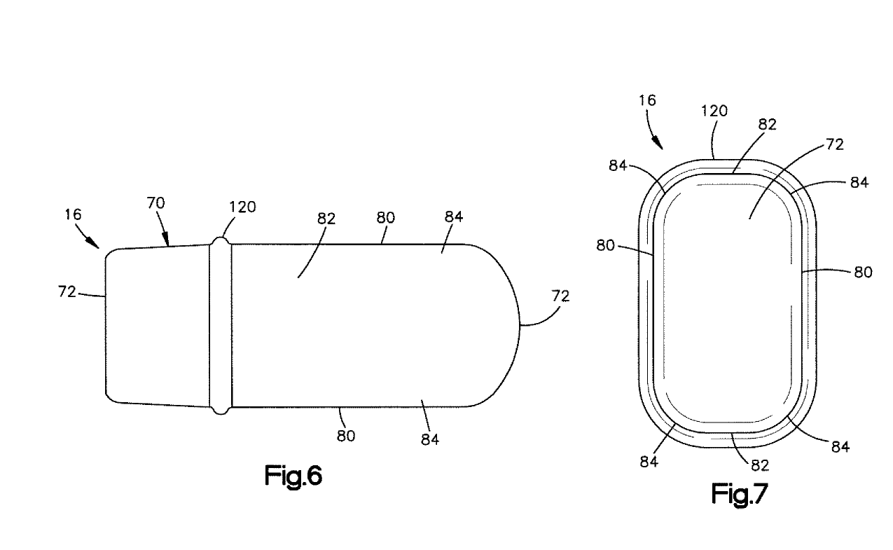

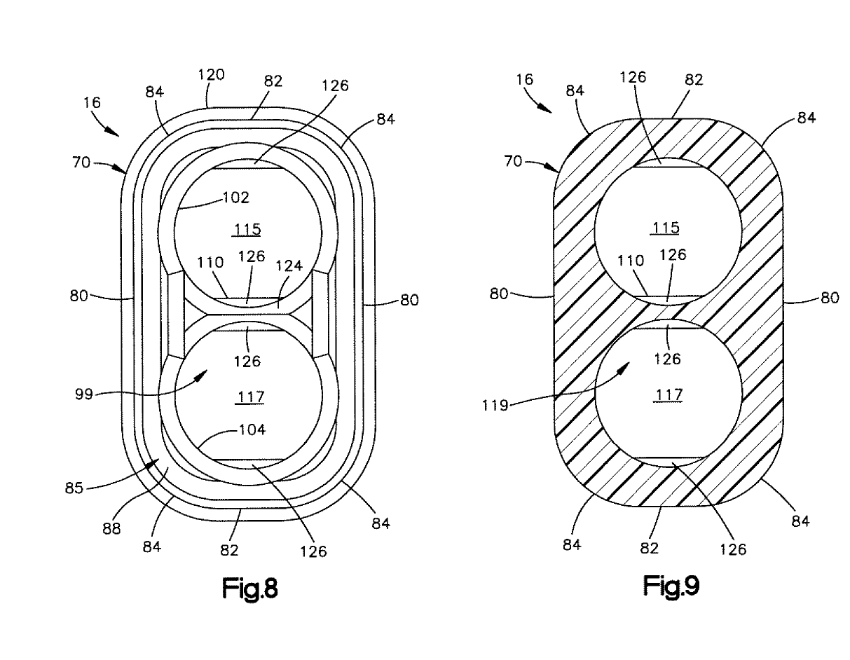

The wax guard 16 is formed of hard plastic that does not flex significantly under normal conditions. As shown separately in FIGS. 4-9, the wax guard 16 in the illustrated example is shaped as a sleeve 70 with first and second ends 72 and 74. The sleeve 70 has a generally rectangular configuration defined by major side walls 80, minor side walls 82, and rounded corners 84. The first end 72 of the sleeve 70 defines an opening 85 with a beveled edge 88 (FIG. 5). The second end 74 is closed.

As best shown in FIG. 5, a chamber 99 within the sleeve 70 extends nearly the full length of the sleeve 70. A pair of inner surfaces 102 and 104 with cylindrical contours extend along the length of the chamber 99. An inner wall structure 110 extends across the chamber 99 between the cylindrically contoured inner surfaces 102 and 104, and extends partly along the length of the chamber 99 from the closed end 74 toward the open end 72. In this arrangement, the inner wall structure 110 partitions the chamber 99 into compartments 115 and 117 at locations spaced inwardly from the open end 72. Vents 119 at the side walls 80 of the sleeve 70 communicate the compartments 115 and 117 with the exterior of the sleeve 70.

The user of the hearing aid 10 can place the wax guard 16 in the installed position of FIG. 1 by manually moving it toward and into that position as indicated by the arrow shown in FIG. 2. Specifically, the user moves the sleeve 70 inward through the opening 49 at the end of the passage 47 in the ear mould 14. The opening 49 is slightly smaller than the first end 72 of the sleeve 70 so that the flexible material of the ear mould 14 stretches over the sleeve 70 to establish a releasable interference fit with the sleeve 70. A peripheral rib 120 on the sleeve 70 also help to hold the wax guard 16 securely in place.

As the sleeve 70 is moved inward of the passage 47, the open ends 28 and 30 of the tubes 24 and 26 are received in the chamber 99 through the opening 85 at the open end 72 of the sleeve 70. As the wax guard 16 approaches the installed position, the open ends 28 and 30 of the tubes 24 and 26 enter the compartments 115 and 117, respectively, in the chamber 99. The beveled edge 88 at the opening 85, as well as a beveled edge 124 on the inner wall structure 110, helps to guide the ends 28 and 30 of the tubes 24 and 26 into the compartments 115 and 117. Stop surfaces 126 at the inner ends of the compartments 115 and 117 block the ends 28 and 30 of the tubes 24 and 26 from moving beside the vents 119. The cylindrical inner surfaces 102 and 104 of the sleeve 70 are preferably sized to establish a releasable interference fit with the tubes 24 and 26 in the compartments 115 and 117. With the wax guard 16 installed over the open ends 28 and 30 of the tubes 24 and 26 in this manner, the inner wall structure 110 serves as an acoustical barrier between the tubes 24 and 26, and the vents 119 communicate the tubes 24 and 26 pneumatically with the exterior of the sleeve 70 independently of each other. The relatively rigid plastic material of the wax guard 16 helps to prevent the tubes 24 and 26 from being crimped or crushed near their open ends 28 and 30.

The patentable scope of the invention is defined by the claims, and may include other examples of how the invention can be made and used. Such other examples, which may be available either before or after the application filing date, are intended to be within the scope of the claims if they have structural elements that do not differ from the literal language of the claims, or if they have equivalent structural elements with insubstantial differences from the literal language of the claims.

What is claimed is:

1. An apparatus for use with hearing aid tubes, comprising:
a wax guard configured as a sleeve having an open end, a closed end, a chamber extending between the open and closed ends, vents from the chamber to the exterior of the sleeve, and an inner wall structure that extends from the closed end toward the open end and partitions the chamber into vented compartments, with each vented compartment configured to receive a hearing aid tube inwardly through the open end.

2. An apparatus as defined in claim 1 wherein each compartment is configured to receive a hearing aid tube in an interference fit.

3. An apparatus as defined in claim 1 wherein each vent is closer to the second end than to the first end.

4. An apparatus as defined in claim 1 wherein the inner wall structure is configured to separate a hearing aid tube received in a compartment from a hearing aid tube received in another compartment.

5. An apparatus as defined in claim 1 wherein the inner wall structure has a beveled edge between the compartments.

6. An apparatus comprising:
a wax guard including a sleeve having an open end, a closed end, vents, and an inner wall structure partitioning the interior of the sleeve into first and second compartments;
a hearing aid sound tube extending into the first compartment through the open end; and
a hearing aid vent tube extending into the second compartment through the open end.

7. An apparatus as defined in claim 6 wherein each tube is received in its respective compartment in an interference fit with the sleeve.

8. An apparatus as defined in claim 6 wherein the vents are located closer to the closed end than to the open end.

9. An apparatus as defined in claim 6 wherein the inner wall structure is configured to separate the hearing aid sound tube extending into the first compartment from the hearing aid vent tube extending into the second compartment.

10. An apparatus as defined in claim 6 wherein the inner wall structure has a beveled edge between the compartments.

11. An apparatus comprising:
an electronic hearing device having a vent tube, a sound tube, a housing, and a control interface;
an ear mould configured to receive the electronic hearing device in an installed position and having a passage in which the vent and sound tubes extend when in the installed position; and
a wax guard configured for insertion in the passage and having an open end, a closed end, a chamber extending between the open and closed ends, vents from the chamber to the exterior of the wax guard, and an inner wall structure that partitions the chamber into vented compartments, with the vented compartments configured to receive the vent and sound tubes inwardly through the open end.

12. An apparatus as defined in claim 11 wherein the vented compartments are configured to receive the vent and sound tubes in an interference fit.

13. An apparatus as defined in claim 11 wherein the inner wall structure is configured to separate the vent tube received in a compartment from the receiver tube received in another compartment.

14. An apparatus as defined in claim 11 wherein the inner wall structure has a beveled edge between the compartments.
